(19) United States
(12) Patent Application Publication
(10) Pub. No.: US 2026/0202792 A1
(43) Pub. Date: Jul. 16, 2026

(54) DISPLAY DEVICE AND SYSTEM FOR DISPLAYING A HOLOGRAM

(71) Applicants: Hübner GmbH & Co. KG, Kassel (DE); Carl Zeiss Jena GmbH, Jena (DE)

(72) Inventors: Daniel HÜBSCH, Fuldabrück (DE); Konrad Philipp BRIMO, Düsseldorf (DE); Viktor SCHUETZ, Jena (DE)

(73) Assignees: Hübner GmbH & Co. KG, Kassel (DE); Carl Zeiss Jena GmbH, Jena (DE)

(21) Appl. No.: 19/430,917

(22) Filed: Dec. 23, 2025

(30) Foreign Application Priority Data
Jan. 7, 2025 (EP) 25150583.0

(51) Int. Cl. G03H 1/00; G03H 1/02

(52) U.S. Cl. CPC G03H 1/0005; G03H 1/0248; G03H 1/0256; B60K 2360/29; G03H 2001/0212; G03H 2223/23; G03H 2250/32; G03H 2250/39

(57) ABSTRACT

According to one aspect of the disclosure, a display device for a public passenger transportation facility for displaying an image is provided. The display device comprises a diffractive film which includes a volume grating and is configured to display incident light having a predetermined wavelength in an angle-specific viewing region. The display device furthermore comprises an imaging light source for emitting light having the predetermined wavelength. The imaging light source is arranged at a distance from the diffractive film. The imaging light source is configured to illuminate the diffractive film.

### CROSS-REFERENCE TO RELATED APPLICATIONS

This application claims priority to European Application No. 25150583.0, filed on Jan. 7, 2025, which is hereby incorporated by reference in its entirety.

### FIELD

The present disclosure relates to a transparent display which can preferably be retrofitted, preferably in means of transport for public passenger transport.

### BACKGROUND

Retrofittable displays in public transport infrastructure enable the provision of additional information and/or enable entertainment for passengers. However, in the case of conventional display systems, there are challenges with regard to the complexity, the provision costs and in particular with regard to the integration of conventional display systems into existing infrastructures.

The display areas in conventional objects, such as, for instance, means of transport, stops or platforms, for public passenger transport are restricted to isolated display devices. Such display devices also compete with the (interior) space available for passengers. A need for a further display area can currently scarcely be met without losses in the passenger capacity. Therefore, above all, the space requirement of current displays and the fastening thereof and the electrical connection thereof in the object presents operators with great challenges.

Conventional display panels in objects for public passenger transport also enable no interaction of the user or of the passenger with the displayed information.

Furthermore, conventional display panels are exposed to the harsh conditions in the objects. These include large temperature fluctuations, moisture, vibrations due to weather influences and/or the movement of the means of transport and the effect of mechanical force due to vandalism.

### SUMMARY

There is therefore a need for a display device which can be additionally fitted or retrofitted in public passenger transportation facilities without having to accept losses in the passenger capacity.

It is an object of the disclosure to provide a display device for window areas which furthermore ensures high visibility of the window areas.

It is a further object of the disclosure to provide a display device which has the widest possible viewing angle.

It is furthermore an object of the disclosure to provide a system corresponding thereto which can be integrated in virtually every means of transport for public passenger transport and in the process uses the existing glass areas as a display.

It is furthermore an object of the disclosure to provide a system which enables interaction with information displayed by a display device.

A further object is to provide a display device which is sufficiently robust for use in public passenger transportation facilities.

At least one of these objects is achieved by the features of the display device according to independent claim 1 or by the features of the independent system claim corresponding thereto. Developments of the disclosure are specified in the respective dependent claims.

The disclosure is based on the concept of providing a display device for a public passenger transportation facility for displaying an image, wherein the display area may be configured as a transparent diffractive film and may thereby be arranged on window areas of a means of transport for public passenger transport without noticeably darkening the window.

According to one aspect of the disclosure, a display device for displaying a hologram is provided. The display device comprises a diffractive film which includes a volume grating and is configured to display incident light having a predetermined wavelength in an angle-specific viewing region or to direct it into the viewing region. The display device further comprises an imaging light source for emitting light having the predetermined wavelength. The imaging light source is arranged at a distance from the diffractive film. The imaging light source is configured to illuminate the diffractive film directly or directly.

“Directly illuminate” means that no deflection of the emitted light beams is necessary between the imaging light source and the diffractive film in order to image the emitted light onto the diffractive film. In particular configurations, indirect illumination is also possible, wherein the emitted light is deflected via optical elements in order to illuminate onto the diffractive film.

According to a further aspect of the disclosure, a system is provided. The system comprises a public passenger transportation facility, such as, for instance, a carriage, wagon or car body for a means of transport and/or a facility for public passenger transport, e.g. bus stops or station displays. The system further comprises at least one display device according to the above aspect of the disclosure. The imaging light source is connected to a supply infrastructure of the object or car body and/or integrated in the lining thereof.

The display device according to the disclosure has the advantage that it can be retrofitted with simple means, in particular in the passenger compartment of a means of transport for public passenger transport or to infrastructure adjacent thereto. The diffractive film can be arranged on or on existing traffic areas, for example window areas, luggage storage areas, wall areas, door areas, ceiling areas and/or wind catching areas. The imaging light source, which can be approximately the size of a cigarette box, can likewise be arranged without difficulty for illuminating the diffractive film. As a result, in particular in public means of transport, new display areas can be created cost-effectively.

Within the scope of the disclosure, the transport of people by public transport companies is considered to be public passenger transport. The public passenger transport can comprise both local passenger transport and long-distance passenger transport. As means of transport for public passenger transport, in particular any type of buses, taxis, road and city railways, trains, ships, helicopters and aircraft comes into consideration. In one embodiment, the public passenger transportation facility may be a rail vehicle. Each of these means of transport has a passenger compartment in which the display device according to the disclosure can be retrofitted, i. e., arranged when the respective facility is ready for operation or at least fully manufactured. Likewise, the display device according to the disclosure can be retrofitted in facilities such as, for instance, stops, elevators, platforms, etc.

The display device and the system according to the above aspects of the disclosure can further comprise one or more of the following features:

The display device may further comprise an interface to a control unit for receiving an image signal. The imaging light source may be configured to emit a light, wherein the light represents the image signal.

The diffractive film may include a microstructure introduced by laser light having the predetermined wavelength. The microstructure may comprise a diffraction structure. The microstructure may comprise a volume hologram. The microstructure may comprise a volume grating. Within the scope of the present disclosure, a volume hologram may denote a grating structure in the diffractive film which is introduced, engraved or exposed by exposure of the diffractive film by means of coherent laser light of a predetermined wavelength, for example using the photorefractive effect. The grating structure or the volume grating may have a spatially periodic change in the refractive index in one direction. The grating structure or the volume grating may have a predetermined number of Bragg planes. The diffractive film may be formed as a holographic diffuser. The diffractive film may comprise a holographic film. The diffractive film may form a display panel of the display device. The diffractive film may be retrofitted particularly simply as a mechanical element since no connection to an electrical supply is required.

The volume grating of the diffractive film may have a plurality of partial gratings. The partial gratings may each be introduced by exposure to laser light having a predetermined wavelength. The plurality of partial gratings may each be designed for a predetermined wavelength having a certain bandwidth (of ±10 nm, for example). These may be wavelengths for red, green and blue light, for example. A multicolored image may thereby be deflected. The imaging light source is preferably adapted thereto and configured to generate corresponding color partial images. These color partial images may be generated simultaneously or so quickly in succession that a viewer can perceive them only in superposition as a multicolored image.

The viewer may perceive the image emitted by the imaging light source exclusively within the viewing region. The viewing region may extend in a direction perpendicular to a direction of movement of the public passenger transportation facility.

The display device may further have a holographic filter, as described in DE 10 2021 108 354 A1, for example. Interfering light can thereby be prevented.

The diffractive film may have a transparency of at least 90%, preferably at least 94% and particularly preferably 96%. As a result of such a high transparency of the diffractive film, the diffractive film may be arranged on a window pane without noticeably influencing its visibility for a viewer. The diffractive film may be a polymer film.

The term “transparency” may refer herein to a transparency over a wavelength range including visual light and optionally infrared light. The transparency of the diffractive film may be determined by irradiating the diffractive film by a collimated light beam of known intensity and measuring the transmitted intensity. The ratio of the transmitted intensity and the known intensity, i. e., the total transmittance, may indicate the degree of transparency of the diffractive film.

The inventors have recognized that the window areas in means of transport or public transportation facilities are a considerable area which has hitherto been scarcely used or unused technically. On account of the high transparency of the diffractive film, large area regions may therefore be retrofitted in conventional means of transport subsequently with the display device according to one aspect of the disclosure. The diffractive film of the display device may be attached to the surface of a window area in means of transport or public passenger transportation facilities, e. g., using an adhesive.

The imaging light source may be arranged on a viewer side of the diffractive film. The viewer side may be the display side of the diffractive film, i.e. the imaging light source and a viewer may be located on the same side of the diffractive film. The diffractive film may be configured to display no image on that side which faces away from the imaging light source. The imaging light source may be arranged outside a field of view of a viewer of the diffractive film. The imaging light source may be arranged in a half-space on the viewer side. The imaging light source may comprise a laser. That is to say that the diffractive film and the imaging light source are arranged, for example, in the interior of the means of transport. As a result, the displayed information may be recognized only from the inside or from the interior of the means of transport. When the diffractive film is viewed from an outer surface, i.e. from outside the means of transport, the information is not recognizable. In a particular embodiment, however, the diffractive film may also be configured in such a way as to display the image only on that side which faces away from the imaging light source. This setting of the diffractive film may be controlled by the volume grating introduced therein.

The imaging light source may have a direct distance from the center of the diffractive film and a distance from the plane which is defined by the diffractive film. The direct distance may be greater than the distance by a factor in the range from 2 to 5. The distance from the plane is in this case the distance from the imaging light source to the imaginary magnification of the film, i.e. the distance is perpendicular to the film or there is a right angle between the distance line and the film. That is to say that the imaging light source may be arranged offset outside the diffractive film and in this case nevertheless illuminate the diffractive film. The imaging light source may be arranged substantially closer to the plane which is defined by the diffractive film than to the center of the diffractive film. As a result of this arrangement, it can be ensured that no viewer can intervene in the beam path between the imaging light source and the diffractive film. Shading of the displayed image by viewers can thus be avoided.

The imaging light source may comprise an image generator and a control unit with a processor. The control unit may drive the image generator to generate a multicolored image. The image generator may be an LCD module, an OLED module or an LCoS module or a tilting mirror matrix. Furthermore, the image generator may have a matte screen.

The multicolored image may be generated by means of the image generator in that, for example, three color partial images having different wavelengths are generated. These may be, for example, a blue color partial image having a wavelength of 460 nm, a green color partial image having a wavelength of 500 nm and a red color partial image having a wavelength of 640 nm. The color partial images may be generated simultaneously or alternately so quickly in succession in time that only the superposition can be perceived by a viewer as a multicolored image.

A beam-shaping optical unit may be arranged between the imaging light source and the diffractive film. The distance, in particular the direct distance and/or the perpendicular distance, between the imaging light source and the diffractive film may be reduced by the beam-shaping optical unit. The beam-shaping optical unit may enable the illumination of a relatively large diffractive film by a light source having a relatively short distance from the diffractive film.

The imaging light source may be arranged in such a way that the emitted light is incident on the diffractive film at an angle of incidence of at least 8°. In this configuration, total reflection of the incident light at the diffractive film can be avoided.

The diffractive film and the imaging light source may be arranged on a traffic area of the public passenger transportation facility and/or on a window area of the public passenger transportation facility, in particular in an interior of a means of transport for public passenger transport. The traffic area and/or the window area may be oriented perpendicular to its direction of movement and/or to the direction of movement of the public passenger transportation facility. The diffractive film may preferably be arranged on a window area of the means of transport. The diffractive film may be cohesively connected to the window area of the means of transport. The diffractive film may be releasably connected to the window area of the means of transport, preferably releasably without residue. The imaging light source may preferably be arranged above the diffractive film on a ceiling of the means of transport not far from the diffractive film. The diffractive film may preferably include a self-adhesive side with which it is fastened or attached to the window area. The diffractive film may be configured to be retrospectively arranged in or at the public passenger transportation facility, in particular to a (non-windshield) window area of the public passenger transportation facility. The diffractive film may be detachably connected to the public passenger transportation facility to enable an exchange of the diffractive film. The diffractive film may be firmly bonded to the public passenger transportation facility, in particular via the self-adhesive side.

The display device may further include a protective film and/or an antireflection film. The protective film and/or the antireflection film may be arranged on the diffractive film, in particular on the viewer side or display side. The protective film may protect the diffractive film against mechanical influences from the surroundings. Likewise, the protective film may prevent detachment, damage or removal of the diffractive film or at least make it considerably more difficult. For this purpose, the protective film may in particular have a scratch-resistant surface. The protective film and/or the antireflection film may be cohesively connected to the diffractive film. The protective film and/or the antireflection film may be larger than the diffractive film in order to cover the edges of the diffractive film. The protective film and/or the antireflection film may be constructed in multiple layers in order to assume various optical and/or mechanical functions. The protective film and/or the antireflection film may preferably include a self-adhesive side with which it is fastened to the diffractive film and the window area.

In one embodiment, the display device may comprise a glass pane, preferably made of armoured glass, which can be arranged on the viewer side in front of the diffractive film. By shielding the diffractive film by means of an additional glass pane, the protection of the diffractive film, in particular against vandalism, can be considerably improved.

Furthermore, the imaging light source may include a protective hood or a protective cassette in order to protect the imaging light source against environmental influences and/or vandalism.

The diffractive film may have a decoupling angle for displaying the hologram, which differs from the angle of incidence of the light of the imaging light source. As a result, the light of the imaging light source may be projected with a solid angle which can be easily seen by seated and/or standing viewers in the means of transport for public passenger transport. The diffractive film may comprise a microstructure which is configured to display the light of the imaging light source perpendicular to the diffractive film with an aperture angle in the range from 30° to 60°, preferably 40° to 50°.

The display device may further comprise a control device which is connected to the imaging light source by a communication channel. The control device may be configured to generate and/or receive an image signal and to provide the image signal to the imaging light source via the communication channel. The imaging light source may receive the image signal and convert it into a light having the predetermined wavelength corresponding to the image signal. The image signal may comprise control data or a source control signal, based on which the imaging light source can emit the light. The predetermined wavelength may be selected from a predetermined wavelength range. The image signal may contain instructions for the imaging light source for emitting a light representing the image signal, wherein the emitted light may be deflected into the viewing region by interaction of the emitted light with the diffractive film. The control device may generate or adapt the image signal itself. The control device may further comprise an interface for remote control, so that the image signal can be provided externally. The image signal may be dynamically adapted and/or updated. The updating of the image signal may be effected remotely (“over-the-air”). In particular, dynamic image sequences, clips and/or videos can be provided as an image signal by updating the image signal and can be deflected into the viewing region by the diffractive film.

The communication channel may be wireless and/or wired. The imaging light source may comprise a receiver by means of which the image signal can be received by the control device. The control device may be a central carriage control unit of the means of transport for public passenger transport. Alternatively, the control device may be arranged with the imaging light source in a common housing.

The display device may further comprise at least one sensor unit. The control device may be configured to receive or request a sensor signal from the at least one sensor unit and to control the light of the imaging light source based on the sensor signal. For this purpose, the control device can adapt the image signal based on the sensor signal.

At least one of the at least one sensor unit and the control device may be arranged in a common housing. As a result, the number of physical components for retrofitting the display device can be reduced.

The at least one sensor unit may comprise a position sensor. The position sensor may be configured to determine coordinates of the display device, for example based on a global navigation satellite system (GNSS), such as GPS, GLONASS, Galileo, Beidou, and so on. The sensor signal may comprise a position value. The position value may comprise geographical coordinates with longitude and latitude. The position value may comprise a route section or route progress along a predefined conveying route of the means of transport. The position value may specify a stop code and/or stop name. The control device may be configured to adapt the image signal based on the position value. For example, the image signal may comprise a content which is matched to the current location of the display device. This enables, for example, the display of information on points of interest or stops in real time. When approaching a stop, for instance under the ground, the control device may provide the imaging light source with an image signal by means of which a three-dimensional position plan of the stop and the outputs thereof can be displayed.

The at least one sensor unit may comprise a light sensor. The light sensor may be formed as a photodiode or photometer or luxmeter and may be configured to determine the light intensity on account of ambient light. The sensor signal may comprise a brightness value.

If the sensor signal comprises a brightness value, the control device may be configured to control a light intensity of the imaging light source based on the brightness value. The control device may be configured to continuously increase and/or reduce the light intensity depending on the brightness value.

The at least one sensor unit may comprise a camera. The camera may be configured to capture the angle-specific viewing region. The camera may be configured to capture a viewer interaction in the viewing region or movement on or in front of the diffractive film.

The at least one camera may include a viewing region which comprises the diffractive film and the angle-specific viewing region thereof. If the system has a plurality of cameras, the plurality of cameras can have a combined viewing region which includes at least the viewing region illuminated by means of the diffractive film. The one or more cameras may recognize interactions of a viewer or of a passenger with the information displayed by the diffractive film. In other words, the camera may recognize gestures of the viewer in conjunction with the information displayed by the display device. The camera may generate a control signal based on a recognized gesture. The control device, which may be configured to communicate with the camera, may generate the image signal based on the camera signal or the control signal of the camera and preferably provide it to the imaging light source. The control device may furthermore control facility-specific functions, such as, for instance, the opening of a door and/or the transmission of a stop request, based on the camera signal or the control signal of the camera. By converting gestures of the viewer into an image signal or control signal, interaction of the viewer or passenger with the display device and/or the public passenger transportation facility is enabled. Already existing monitoring cameras may be used as a camera in conventional carriage bodies. For a more detailed capture of gestures in an interaction in the viewing region, an additional camera may be provided. Consequently, the interaction of the viewer with a display device according to the disclosure can likewise be retrofitted.

Alternative interaction possibilities with the display device according to one aspect of the disclosure may be provided by capacitive gesture control, projected-capacitive touchscreens (PCAP), resistive touchscreens or infrared touchscreens. Such sensor systems may require a connection of the diffractive film to a power supply and is therefore better suited for the production of new window panes than for simple retrofitting on existing window panes.

The capacitive gesture control may combine 2D touch functionality with 3D gesture control. As a result, touches on the display panel and also contactless inputs by hand movements may be captured and each converted into a control signal. The capacitive gesture control may be integrated into existing systems and is suited in particular for small to medium display sizes.

The projected-capacitive touch functionality is known from conventional smartphones and tablets. Such touchscreens are robust and suited for harsh surroundings since they are protected by a glass cover.

Resistive touchscreens are configured to respond to pressure. They can be operated with a stylus or with a finger.

Infrared touchscreens may use a grid of infrared rays for touch recognition. As a result, user interactions may be captured quickly. Larger display panels may also be covered by the grid of infrared rays.

The system may further comprise a central facility control device which is configured to generate and/or receive an image signal and to provide the image signal to the at least one display device.

In summary, the display device according to the disclosure may bring about a conversion of window areas into displays in means of transport for passenger transport and thus create diverse possibilities for information communication. By updating image signals remotely and/or based on captured coordinate pairs, information may be provided dynamically, in accordance with the situation and currently via the display device. The use of protective films and/or armoured glass coverings may increase the robustness of the display device and thereby meet requirements for public transport.

### BRIEF DESCRIPTION OF FIGURES

The disclosure or further embodiments and advantages of the disclosure are explained in more detail below with reference to drawings, wherein the drawings describe only embodiments of the disclosure. Identical components are provided with the same reference signs in the drawings. Elements which are drawn using dashed lines are considered to be optional elements. The drawings should not be regarded as true to scale, and individual elements of the drawings can be illustrated in an exaggerated large or exaggerated simplified form.

FIG. 1 shows a schematic side view of an embodiment of the display device according to an aspect of the disclosure.

FIG. 2 shows a perspective schematic view of an embodiment of the system according to an aspect of the disclosure.

FIG. 3 shows a perspective schematic view of a further embodiment of the system according to an aspect of the disclosure.

FIG. 4 shows a flow diagram of a control method of the display device according to an aspect of the disclosure.

### DETAILED DESCRIPTION

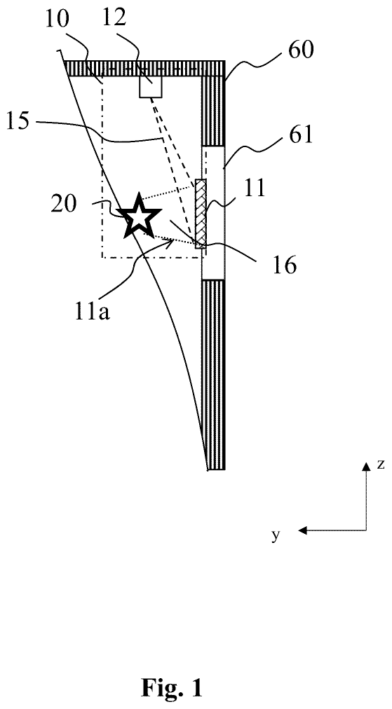

FIG. 1 shows a schematic side view of an embodiment of the display device 10 according to an aspect of the disclosure.

The public passenger transportation facility 60 may be or include a carriage body. The display device 10 comprises a diffractive film 11 and an imaging light source 12. As illustrated in FIG. 1, the diffractive film 11 may be arranged on a window area 61 of the carriage body of a means of transport for public passenger transport. A corresponding detail of a carriage body is illustrated in the side view of FIG. 1. The display side 11a of the diffractive film 11 is directed into the interior of the carriage body, illustrated as y-direction in FIG. 1.

The diffractive film 11 may include a microstructure which is engraved by laser light having a predetermined wavelength or a predetermined wavelength range or is exposed as a volume hologram. As a result, the diffractive film 11 is configured, when illuminated with light 15 having the predetermined wavelength or from the predetermined wavelength range, to generate or display, at a suitable angle, a viewing region 20 at a distance from the diffractive film 11 in the y-direction. For this purpose, a deflected light beam 16 is coupled out by means of the microstructure of the diffractive film 11. The viewing region 20 is illustrated as star in FIG. 1.

The shape of the viewing region 20 is controlled by the imaging light source 12. The imaging light source 12 is configured to emit the light corresponding to an image signal. The imaging light source 12 may be a projector, for example. The imaging light source 12 is arranged close to the plane which is defined by the diffractive film 11 in such a way that the light 15 is incident on the diffractive film 11 at an acute angle of incidence of at least 8°. As illustrated in FIG. 1, the imaging light source may be arranged at a distance from the diffractive film 11 in the z-direction and y-direction.

In FIG. 1, the light beams emitted by the imaging light source 12 are sketched by dashed lines and the light beams 16 deflected out of the diffractive film 11 are sketched as dotted lines.

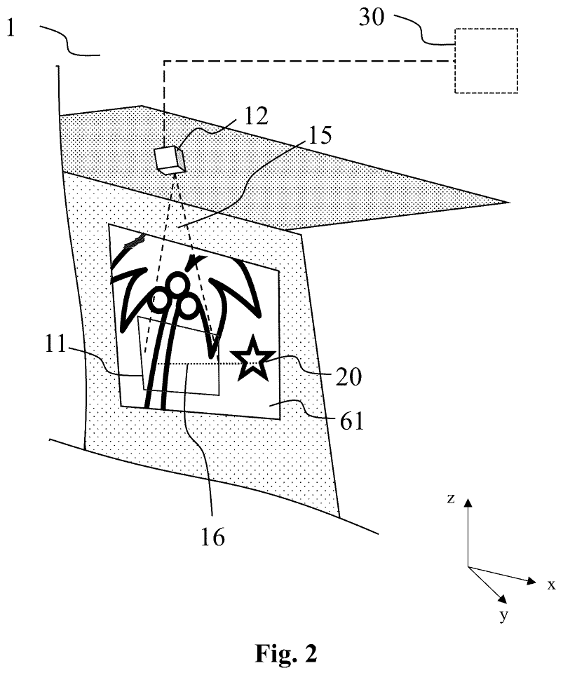

FIG. 2 shows a perspective schematic view of an embodiment of the system 1 according to an aspect of the disclosure.

The public passenger transportation facility 60 may be or include a carriage body. An inner view of a window area 61 of the carriage body is illustrated in FIG. 2. A palm may be recognized from outside the carriage body through the window area 61. A diffractive film 11, as described above with reference to FIG. 1, for example, may be arranged on the window area 61. An imaging light source 12 is arranged at a distance from the diffractive film 11 on the ceiling of the carriage body. The imaging light source 12 is configured to directly illuminate the diffractive film 12 having a predetermined wavelength or a predetermined wavelength range.

The imaging light source 12 may receive an image signal from a control device 30. For this purpose, the display device may include a corresponding interface (not shown). The image signal may control the imaging light source 12.

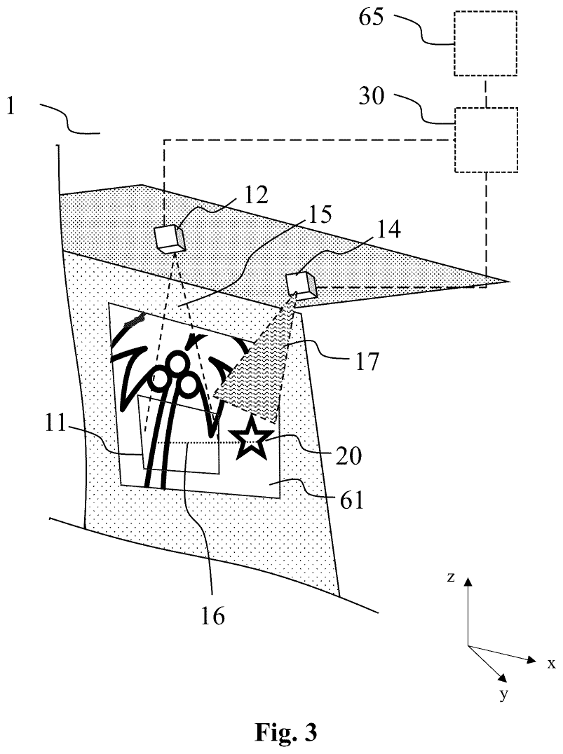

FIG. 3 shows a perspective schematic view of a further embodiment of the system 1 according to an aspect of the disclosure.

The illustration of FIG. 3 is based on that of FIG. 2 and furthermore comprises a sensor unit 14. The sensor unit 14 of FIG. 3 may be formed as a camera. The camera may include a viewing region 17, by means of which the viewing region 20 and a passenger interaction in the viewing region 20 may be captured and/or interpreted. By capturing, for example, the hand movement of a passenger in conjunction with the image deflected into the viewing region 20, a gesture of the passenger may be determined. Based on the determined gesture, the camera may provide a sensor signal. The sensor signal may comprise a viewer interaction. The control device 30 may furthermore be configured to receive or request the sensor signal from the camera and to generate an image signal and/or an facility-specific control signal based on the sensor signal. As a result, the display device or the facility may be controlled interactively by the user/viewer.

A central carriage control device 65 is furthermore illustrated in FIG. 3, which may be connected in a data-communicating manner to the display device 10, for example by means of the control device 30.

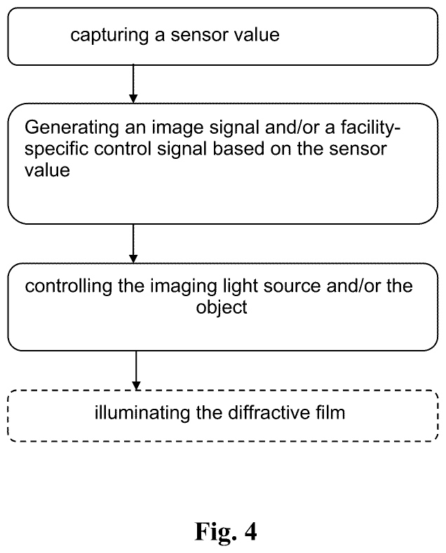

FIG. 4 shows a flow diagram of a control method of the display device 10 according to an aspect of the disclosure.

The method may comprise capturing a sensor value in a first step. The sensor value may comprise, for example, a position value, a brightness value and/or a user interaction with the display device.

The method may comprise generating an image signal and/or a facility-specific control signal based on the sensor value in a second step.

The method may comprise controlling the imaging light source 12 in a third step. The method may comprise controlling the public passenger transportation facility 60 in the third step. This third step may be based on the image signal or the control signal of the second step. That is to say that the image signal may prompt the control of the imaging light source 12. The control signal may be a gesture control signal.

The method may comprise illuminating the diffractive film 11 in an optional fourth step. For this purpose, the imaging light source 12 may emit a light which represents the image signal. The light has a predetermined wavelength or a predetermined wavelength range.

As a direct consequence of the fourth step, the light of the imaging light source 12 may be deflected into a viewing region 20 by means of the diffractive film 11. In the viewing region 20 (“eye box”), the information represented by the image signal may be represented in a manner which can be easily recorded by the viewer.

Alternatively, a public passenger transportation facility-specific function may be carried out in the fourth step.

1. A display device for a public passenger transportation facility for displaying an image, comprising:
a diffractive film which includes a volume grating and is configured to display incident light having a predetermined wavelength in an angle-specific viewing region; and
an imaging light source for emitting light having the predetermined wavelength;
wherein the imaging light source is arranged at a distance from the diffractive film and is configured to illuminate the diffractive film; and
wherein the diffractive film has a self-adhesive side for attaching the diffractive film to a window area of the public passenger transportation facility.

2. The display device of claim 1, further comprising an interface to a control device for receiving an image signal, wherein the imaging light source is configured to emit a light representing the image signal.

3. The display device of claim 1, wherein the volume grating of the diffractive film has a plurality of partial gratings, wherein the partial gratings are each formed by exposure to laser light having a predetermined wavelength.

4. The display device of claim 1, wherein the diffractive film has a transparency of at least 94%, preferably at least 96%.

5. The display device of claim 1, wherein the imaging light source is arranged on a viewer side of the diffractive film, outside a field of view of a viewer of the diffractive film.

6. The display device of claim 1, wherein the imaging light source is arranged in such a way that the emitted light is incident on the diffractive film at an angle of incidence of at least 8°.

7. The display device of claim 1, wherein the diffractive film is arranged on a traffic area of the facility and/or on a window area of the facility.

8. The display device of claim 1, further comprising a protective film or an antireflection film which is or are arranged on the diffractive film, wherein the protective film or antireflection film overlaps the diffractive film on at least one side and preferably has a larger area than the diffractive film.

9. The display device of claim 1, further comprising a control device which is connected to the imaging light source by a communication channel and is configured to generate or receive an image signal and to provide the image signal to the imaging light source via the communication channel, wherein the communication channel is preferably wireless.

10. The display device of claim 9, further comprising at least one sensor unit,
wherein the control device is configured to receive or request a sensor signal from the at least one sensor unit and to control the light of the imaging light source or a facility-specific function based on the sensor signal.

11. The display device of claim 10, wherein at least one of the at least one sensor unit and the control device are arranged in a common housing.

12. The display device of claim 10,
wherein the at least one sensor unit comprises a position sensor and the sensor signal comprises a position value;
wherein the at least one sensor unit comprises a light sensor and the sensor signal comprises a brightness value; and
wherein the at least one sensor unit comprises a camera and the sensor signal comprises a viewer interaction, in particular gesture control.

13. The display device of claim 10, if the sensor signal comprises a brightness value, the control device is configured to control a light intensity of the imaging light source based on the brightness value, in particular to continuously increase or reduce the light intensity depending on the brightness value.

14. A system, comprising:
a public passenger transportation facility; and
at least one display device according to claim 1, which is arranged in or on the facility;
wherein the imaging light source is connected to a supply infrastructure of the facility.

15. The system of claim 14, further comprising a central facility control device which is configured to generate or receive an image signal and to provide the image signal to the at least one display device.
